(19) United States
(12) Patent Application Publication
(10) Pub. No.: US 2024/0199093 A1
(43) Pub. Date: Jun. 20, 2024

(54) BOXCAR DOOR MECHANISM

(71) Applicant: Trinity Rail Group, LLC, Dallas, TX (US)

(72) Inventor: Kenneth W. Huck, Fairview, TX (US)

(21) Appl. No.: 18/545,511

(22) Filed: Dec. 19, 2023

Related U.S. Application Data
(60) Provisional application No. 63/476,180, filed on Dec. 20, 2022.

(51) Int. Cl. B61D 19/00; E05C 9/04

(52) U.S. Cl. CPC B61D 19/005; B61D 19/001; E05C 9/042; E05C 9/048

(57) ABSTRACT

According to some embodiments, a boxcar door operating system comprises a rotating plate, a first lock bar, and a second lock bar. The rotating plate comprises a first lock bar engagement for engaging and disengaging the first lock bar and a second lock bar engagement for engaging and disengaging the second lock bar. An angular position of the first lock bar engagement with respect to a center of rotation of the rotating plate is different than an angular position of the second lock bar engagement with respect to the center of rotation of the rotating plate such that rotation of the rotating plate engages or disengages the first lock bar at a different time than the second lock bar.

### RELATED APPLICATION

This application claims priority to United States Provisional Application Ser. No. 63/476,180, entitled “BOXCAR DOOR MECHANISM,” filed Dec. 20, 2022.

### TECHNICAL FIELD OF THE INVENTION

This disclosure relates generally to doors for a railcar, such as a boxcar.

### BACKGROUND

Particular railcars have doors for loading and unloading of commodities. One example is a boxcar. A boxcar refers to a railcar that is enclosed and generally used to carry freight. Boxcars may have side sliding doors or plug doors of varying size and operation.

### SUMMARY

Particular embodiments are directed to a boxcar door mechanism. For example, according to some embodiments, a door operating system comprises a rotating plate, a first lock bar, and a second lock bar. The rotating plate comprises a first lock bar engagement for engaging and disengaging the first lock bar and a second lock bar engagement for engaging and disengaging the second lock bar. An angular position of the first lock bar engagement with respect to a center of rotation of the rotating plate is different than an angular position of the second lock bar engagement with respect to the center of rotation of the rotating plate such that rotation of the rotating plate engages or disengages the first lock bar at a different time than the second lock bar.

In particular embodiments, the first lock bar engagement is a different size than the second lock bar engagement. The second lock bar engagement may comprise a stop pin.

According to some embodiments, the door operating system comprises a first horizontal rod and a second horizontal rod. The first horizontal rod is coupled to the rotating plate via first slot in the rotating plate and the second horizontal rod is coupled to the rotating plate via a second slot in the rotating plate. A first portion of the first slot is circumferential to the rotating plate and a second portion of the first slot is not circumferential to the rotating plate. A first portion of the second slot is circumferential to the rotating plate and a second portion of the second slot is not circumferential to the rotating plate. The first and second portions of the first slot are offset from the first and second portions of the second slot so that the first horizontal rod and the second horizontal rod start and stop horizontal movement at different times with respect to each other when the rotating plate is rotated.

In particular embodiments, the first horizontal rod comprises a pin and is coupled to the rotating plate via the pin and the first slot. The pin is smaller in diameter than the first slot and when operating the rotating plate in the opening direction the pin is in contact with a first side of the first slot and when operating the rotating plate in the closing direction the pin is in contact with a second side of the first slot opposite the first side. The pin may comprise a low friction material. The pin may comprise a rotating cylinder that facilitates rolling motion between the pin and the first slot.

### BRIEF DESCRIPTION OF THE DRAWINGS

For a more complete understanding of the present disclosure, reference is now made to the following description, taken in conjunction with the accompanying drawings, in which:

FIG. 1 is a side view of a boxcar car illustrating a single plug door;

FIG. 2A is a schematic drawing illustrating a top view and a side view of a door operating system, according to a particular embodiment;

FIG. 2B is a schematic diagram illustrating a top view and a side view of the door operating system in an open position, according to a particular embodiment;

FIG. 2C is a schematic diagram illustrating a top view and a side view of the door operating system in a closed and locked position, according to a particular embodiment;

FIG. 2D is a schematic diagram illustrating a top view and a side view of the door operating system in an open and unlocked position;

FIG. 3 is a flowchart illustrating an example method for opening the door;

FIG. 4 is a schematic diagram illustrating a portion of the door operating system with some elements removed for clarity, according to a particular embodiment;

FIG. 5 is a schematic diagram illustrating section view A-A of FIG. 4;

FIG. 6 is a cross-sectional schematic view of a pin in the slot of the rotating plate during operation, according to a particular embodiment;

FIG. 7 is a cross-sectional schematic view of another pin in the slot of the rotating plate, according to a particular embodiment;

FIG. 8A is a section view B-B from FIG. 7;

FIG. 8B is another section view B-B from FIG. 7;

FIG. 9A is a schematic diagram illustrating lock bar engagements at different angular locations, according to a particular embodiment;

FIG. 9B is a schematic diagram illustrating lock bar engagements at different angular locations, with a lower lock bar disengaged, according to a particular embodiment;

FIGS. 10A and 10B are schematic diagrams illustrating staggered upper and lower lock bar events on a conventional rotating plate, according to a particular embodiment; and

FIGS. 11A and 11B are schematic diagrams illustrating a door operating system where one side of the door opens in advance of the other side, according to a particular embodiment.

### DETAILED DESCRIPTION

Railcar door types vary depending upon the type of railcar (e.g., boxcar), based upon the commodity being transported. Some commodities do not require a tight sealing door and a sliding door is sufficient. The sliding door may or may not use a sealing gasket. Other commodities may require protection from the outside environment, such as rain, and may use an uninsulated plug door, again with or without a sealing gasket. Further protection from the outside environment may be provided by an insulated plug door, such as used on insulated and refrigerated boxcars, and uses a sealing gasket.

Doors are used to close the railcar body access opening to provide security for the railcar contents and protect the commodity from the external environment. A desirable characteristic is that the doors are flush with the inside walls of the railcar when closed to prevent accidentally catching the door edge when moving commodity within the railcar. Another desirable characteristic is that the doors are flush on the outside with the sides of the railcar for safety and aerodynamics.

To access the interior of the railcar, the doors are moved away transversely from the railcar body and rolled on a door track parallel to the railcar sides and attached to the side of the railcar. Restrictions exist on the width of the railcar when the doors are open to provide sufficient clearance for loading docks or other obstacles.

Sliding and plug doors use a mechanism to assist in opening and closing. Sliding doors are usually uninsulated and therefore thinner in thickness than insulated plug doors and require less inward/outward movement than thicker insulated and uninsulated plug doors. Even without a sealing gasket, sliding doors may provide some sealing by overlapping the door and doorposts. To minimize the clearance between the door and the railcar body when closed, the door is rolled in front of the door opening and then moved inward toward the railcar body to fully close. Plug doors also move inward toward the railcar body to fully seal. If the door uses a scaling gasket, this motion also compresses the gasket for a tight seal. When the door is fully closed, lock bars may be engaged to prevent unwanted entry into the interior of the railcar.

Door mechanism designs usually incorporate a handle that is manually rotated to move the door inward during closing and outward when opening. The door is supported on wheels in a track attached to the railcar body. Rotating the handle rotates a plate through a gear mechanism rotationally attached to the door. Attached to the rotating plate are rods that connect to vertical pipes, also rotationally attached to the door to the left and right of the handle such that rotational movement of the plate creates rotational movement of the pipes. Connected to the bottom and top of each pipe is a crank arm that rotates with the pipe and is connected wheels captured on a track, which is connected to the railcar body. Rotation of the handle rotates the plate, which rotates the vertical pipes through the rods, which in turn rotates the crank arms. This moves the door inward or outward with respect to the railcar body depending upon the direction of rotation of the handle.

In addition to moving the door inward and outward, rotation of the handle also engages and disengages lock bars that secure the door to the railcar body. This is accomplished through lock bars also connected to or engaged with the rotating plate. When opening the door, the initial rotation of the handle and rotating plate disengages the lock bar between the railcar body and the door, permitting it to move outward. When closing the door, the final rotational movement of the handle and rotating plate engages the lock bar between the railcar body and the door after the inward movement of the door is sufficient.

The lock bars and the door movement rods are connected to or engaged with the rotating plate symmetrically, meaning that the door latches work in opposite linear directions and the rods for the crank arms are connected to the rotating plate work in opposite directions. When the door is being opened from the fully closed position, the initial movement of the handle and rotating plate move both the lock bar mechanisms and the door crank arm mechanism at the same time. When closing the door, the final movements of the handle also move the crank arms and lock bar mechanisms at the same time.

Sometimes commodity within the railcar may shift against the inside of the doors, putting pressure on the door. The pressure may cause the door to become difficult to open because the increased pressure on the door requires more handle force to open the door. The handle force may exceed the AAR standard or human ergonomic standards.

Existing Association of American Railroads (AAR) standards require that the manual force on the handle not exceed 85 pounds of force for ergonomic reasons. This can be challenging for heavy doors due to friction of door mechanism components at the crank arms and door locks, and while compressing gaskets and moving other appendages on the door.

Particular embodiments described herein reduce sliding or plug door handle operating forces for a better ergonomic experience. Particular embodiments facilitate opening doors where interior commodity may have shifted such that it is pressing outward on the door. Particular embodiments may accomplish these goals by releasing first one set of door latches, then a second set of door latches (if applicable), moving first one side of the door slightly outward, and finally moving the other side of the door outward away from the shifted commodity. By controlling the timing of lock and door movement events, particular embodiments reduce door handle forces.

Particular embodiments will now be described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Existing plug door mechanisms are designed such that the final movement of the handle when closing, or initial movement of the handle when opening, moves both the lock bar mechanisms and crank arm mechanisms at the same time, because both of the mechanisms are attached/engaged to the rotating plate. Particular embodiments described herein include a system for door opening/closing that facilitates movement of the lock bar mechanisms without movement of the crank arm mechanisms, thereby reducing handle forces.

In embodiments that include two sets of lock bars, such as on plug doors, when opening the door, one set of lock bars may be moved and disengaged before the second set of lock bars is disengaged, and both are disengaged before significant door motion away from the railcar body begins. Further, in some embodiments, the right side of the door may begin movement away from the railcar body before the left side. This is beneficial, for example, when closing a plug door with gaskets. In other embodiments, the left side of the door may begin movement away from the railcar body before the right side.

When closing a plug door with gasket compression, the door is rolled in front of the door opening in the railcar body. Rotating the handle moves the door inward toward the railcar body. According to particular embodiments, the left side of the door may move slightly faster inward than the right side such that the left sealing gasket makes contact before the right side. Continued handle rotation compresses the gasket along the top and bottom of the door from left to right until the gasket on the right side is compressed to the same amount as the left side. Due to the design of the rotating plate, continued rotation of the handle stops inward movement of the door and begins to apply first one set of lock bars and then the second set of lock bars.

Particular embodiments provide easier opening when commodity has shifted within the railcar and is applying pressure to a closed door. Initial movement of the handle when unlatching may only attempt to move first one set of lock bars. Continued movement then attempts to move the second set of lock bars (if applicable). This reduces handle forces compared to attempting to unlock both sets at the same time. Continued handle rotation begins moving the right side of the door outward before moving the left side. In many situations, the initial movement is sufficient to move the door enough away from the commodity to relieve the pressure on the door, making the opening cashier. Continued handle rotation finally begins to move the left side of the door, also away from shifted commodity. In other embodiments, the order of the left and right side movements may be reversed.

Thus, particular embodiments reduce the forces required at the handle to open and close railcar doors. Particular embodiments are applicable to sliding doors, uninsulated plug doors, insulated plug doors. etc. Particular embodiments are configurable to provide for a single set of lock bars, multiple sets of lock bars, various amounts of door movement depending on door thickness, and heavy or lighter door weights.

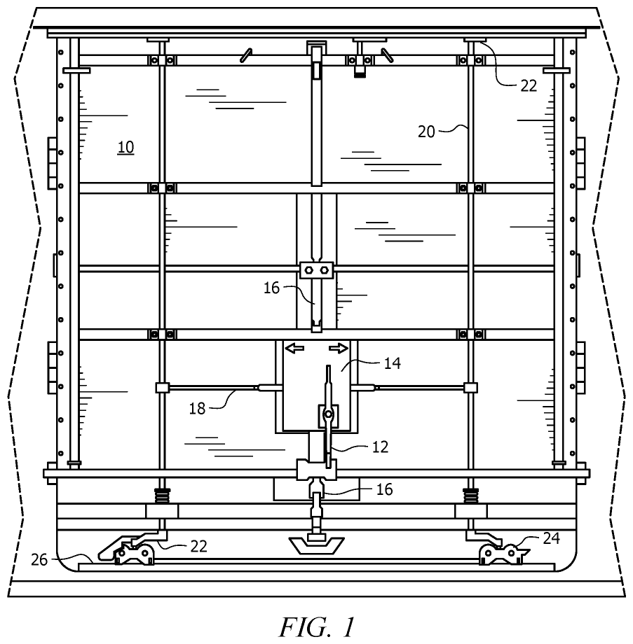

FIG. 1 is a side view of a boxcar car illustrating a single plug door. Door 10 is illustrated in the closed position. To open door 10, handle 12 is rotated in the appropriate direction to operate door mechanism 14, hidden behind a cover in the illustrated example. Initial rotation of door mechanism 14 moves lock bars 16, upper and lower, vertically to disengage the door locks from the railcar body. Disengaging lock bars 16 frees door 10 to move away from the railcar body.

Continuing rotation of handle 12 and door mechanism 14 moves horizontal rods 18 inward toward door mechanism 14. Horizontal rods 18 are attached to cars welded to vertical pipes 20 such that their horizontal motion rotates pipes 20. Attached at the top and bottom of vertical pipes 20 are crank arms 22 that are attached to door support rollers 24 on track 26. As vertical pipes 20 are rotated, crank arms 22 swing through an arc, moving door 10 away from the railcar body. This motion continues until door 10 has sufficiently moved away from the railcar such that door 10 can be moved on track 26, parallel to the sides of the railcar, to provide access to the inside of the railcar.

Although the description above describes the motion of the horizontal rods inward toward the door mechanism to move the door away from the railcar body, in some embodiments the mechanism may move the horizontal rods outward, away from the mechanism, to move the door away from the railcar body. This may be accomplished by changing the direction of the slot in the mechanism plate.

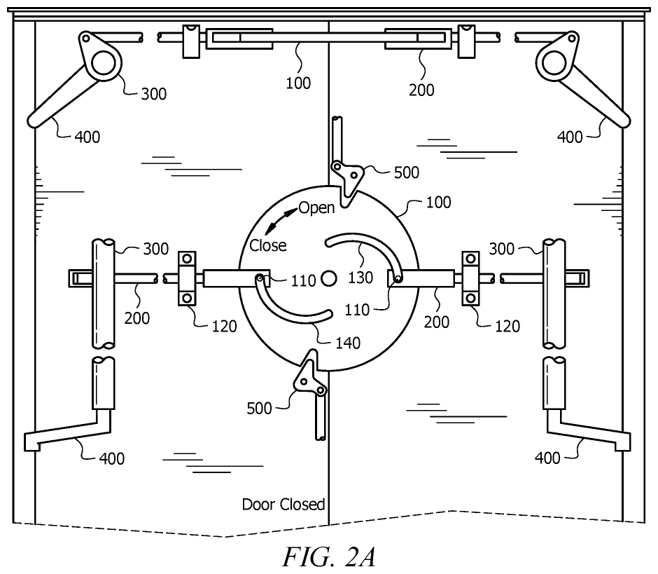

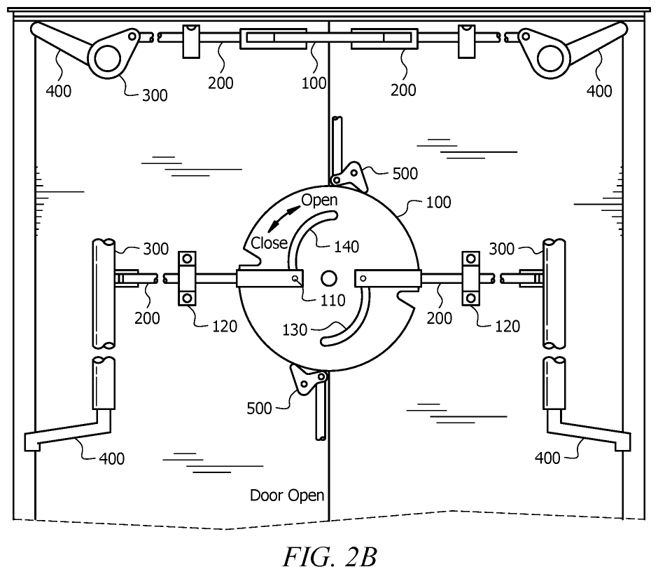

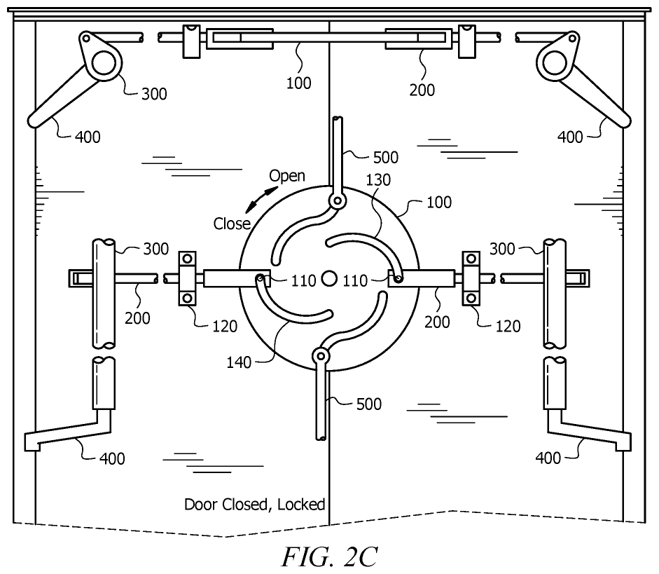

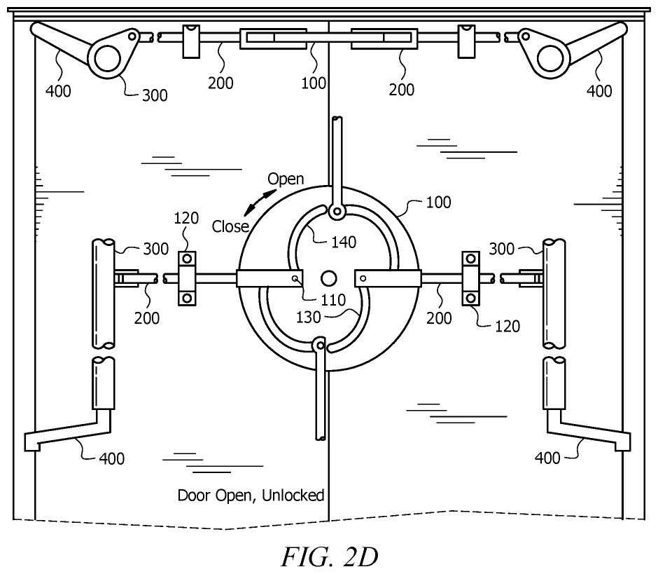

FIGS. 2A-2D are schematic drawings illustrating the components of FIG. 1 in various states of operation.

FIG. 2A is a schematic drawing illustrating a top view and a side view of a door operating system, according to a particular embodiment. Some parts are left off for clarity, such as the door structure, handle and its connection to rotating plate 100, the cover over the door mechanism, and details of lock bars 500. The mechanism is shown for the door in a closed position.

The door operating system includes rotating plate 100 with slots 130 and 140. Pins 110 move in slots 130 and 140. The operating system include guides 120 for horizontal rods 200. Horizontal rods 200 are coupled to pipes 300, which are coupled to crank arms 400. Also illustrated are lock bars 500.

In some of the illustrated examples, horizontal rods 200 are illustrated as partially transparent to expose and show the path of slots 130 and 140.

FIG. 2B is a schematic diagram illustrating a top view and a side view of the door operating system in an open position, according to a particular embodiment. As illustrated, rotating plate 100 has rotated, lock bars 200 are disengaged from rotating plate 100, and vertical pipes 300 and crank arms 400 have rotated.

Both the door horizontal rods and the lock rods may be incorporated into the rotating plate at the same time, permitting all four events to occur as desired with respect to each other: upper lock unlock, lower lock unlock, right side door movement, and left side door movement. This provides reduced handle forces for operation and provides for increased safety. For example, if a load inside the railcar is applying force to the door, such as a leaning load, unlocking the upper locks without unlocking the lower locks may give the door operator an indication that something is amiss. Before unlocking the lower locks, an opportunity exists to determine if it is safe to unlock the lower locks and open the door or whether other actions may be required.

FIG. 2C is a schematic diagram illustrating a top view and a side view of the door operating system in a closed and locked position, according to a particular embodiment. The illustrated example shows the door operating system and rotating plate 100 with both lock bars 500 and both horizontal rods 200 using slots 130 and 140 to move the individual components. The door is in the closed position and lock rods 500 are in their locked position.

FIG. 2D is a schematic diagram illustrating a top view and a side view of the door operating system in an open and unlocked position. The illustrated example shows the door operating system with the door in the open position and lock rods 500 in their released position. By using circumferential slots and the location of the slots, each of these four actions may be timed as desired.

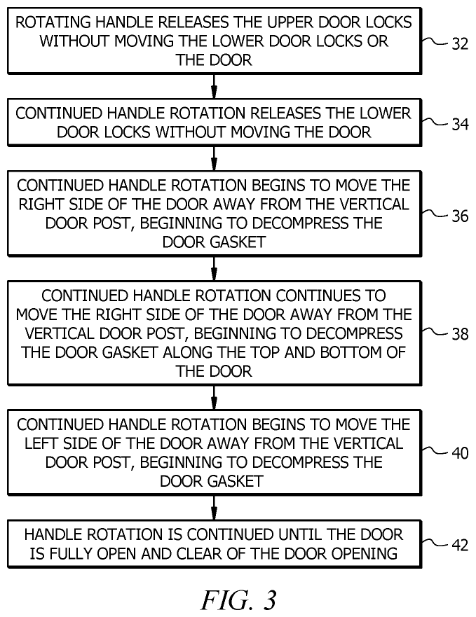

FIG. 3 is a flowchart illustrating an example method for opening the door. The steps of FIG. 3 may be performed, for example, with respect to the components illustrated in FIGS. 1-2D.

The method begins at step 32 where rotating the handle releases upper locks without significantly moving the lower locks or door. At step 34, continued handle rotation releases the lower locks without significantly moving the door. At step 36, continued handle rotation begins to move the right side of the door away from the door post, decompressing the gasket on the vertical right door post. At step 38, continued handle rotation continues to open the door further on the right side to begin decompressing the door gasket across the top and bottom of the door. At step 40, continued handle rotation begins to move the left side of the door away from the door post, decompressing the gasket. At step 42, handle rotation continues until the door is fully open and clear of the door opening.

Reversing the sequence illustrated in FIG. 3 closes and seals the door.

Although particular examples show one possible sequence, other sequences and timing between events may be modified as desired. For example, the lower lock rods may be opened before the upper lock rods, or some of the events may happen offset from each other but be overlapped, or some events may be timed to happen at the same time.

In the illustrated embodiments, rotating plate 100 is rotated in the clockwise direction to disengage the lock bars and unseal/open the door and counterclockwise direction to close/seal the door and engage the lock bars. Other embodiments may reverse the rotational directions to open and close the door.

As illustrated in FIGS. 2A-2D, pin 110 is captured within slots 130 and 140 in rotating plate 100 and pivotally connected to horizontal rods 200. Guides 120 facilitate horizontal rods 200 to move horizontally with respect to guides 120 as pins 110 follows slots 130 and 140 as rotating plate 100 is rotated.

Slots 130 and 140 may not be symmetrical with respect to the center of rotation of rotating plate 100 such that horizontal rods 200 may be moved at different times and rates with respect to each other, if desired.

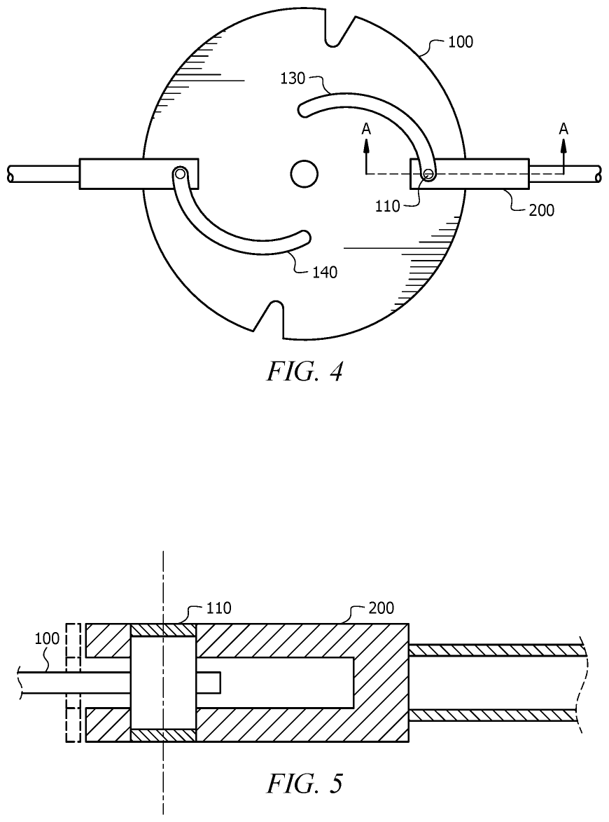

FIG. 4 is a schematic diagram illustrating a portion of the door operating system with some elements removed for clarity, according to a particular embodiment. Section A-A is taken through the connection of horizontal rod 200 to rotating plate 100.

FIG. 5 is a schematic diagram illustrating section view A-A of FIG. 4. The example illustrates rod 200 pivotally connected to rotating plate 100 with pin 110. Pin 110 may be connected to horizontal rod 200 in a variety of methods: pinning, bolting, gluing, etc.

Some embodiments may include low friction washers between horizontal rod 200 and rotating plate 100 to reduce friction during operation (not shown). This may lower the handle effort during operation.

Pin 110 is slightly smaller in diameter than the width of slots 130 and 140 in rotating plate 100 to ensure a bind-free operation.

FIG. 6 is a cross-sectional schematic view of a pin in the slot of the rotating plate during operation, according to a particular embodiment. The illustrated example is a close-up view of pin 110 in slot 130 of rotating plate 100. Operating the mechanism in the closing direction, rotating plate 100 applies force F in one direction to horizontal rod 200 to rotate pipe 300. In this view, pin 110 contacts the left side of slot 130. When operating the mechanism in the opening direction, rotating plate 100 applies force F in a second direction to horizontal rod 200 to rotate pipe 300. In this view, pin 110 contacts the right side of slot 130.

Pin 110 may be made of a variety of materials suitable for the loads, stresses, and acceptable wear and friction. In some embodiments, pin 110 may made of hardened steel, such as a rod or bolt, where the motion between pin 110 and slot 130 is primarily sliding.

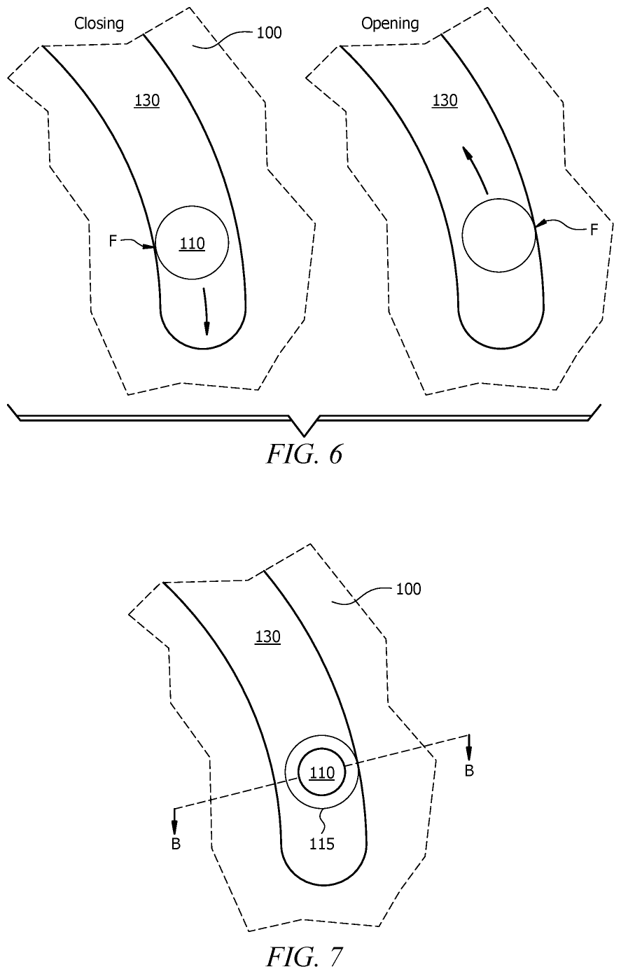

FIG. 7 is a cross-sectional schematic view of another pin in the slot of the rotating plate, according to a particular embodiment. The illustrated examples shows another embodiment with pin 110 within a second cylinder 115 that permits rolling motion between pin 110 and slot 130. Cylinder 115 may be constructed of a variety of different materials that are suitable for the loads and anti-friction properties desired, such as steel, bronze, nylon, etc. Cylinder 115 may be replaceable.

Even with primarily rolling motion between pin 110 and slot 130, some wear may occur over a lifetime of use from environmental debris or other factors. Some embodiments extend the life of cylinder 115 by taking advantage of the different contact surfaces of pulling or pushing in slots 130 and 140 against cylinder 115 during the closing and opening operations.

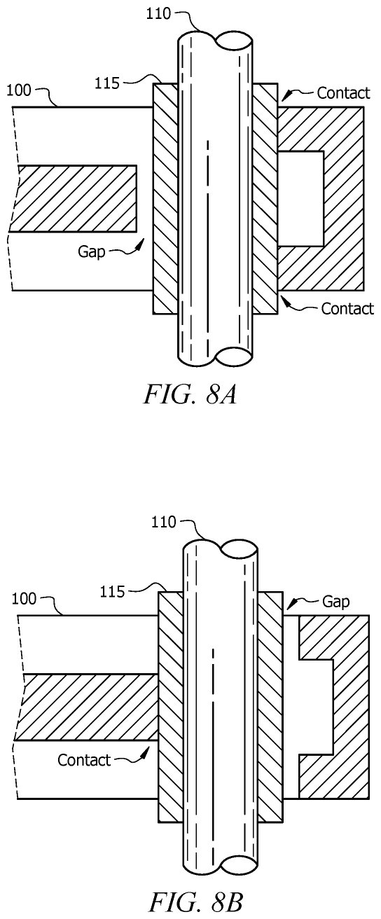

FIG. 8A is a section view B-B from FIG. 7. In the illustrated example, pin 110 and cylinder 115 are against the right side of slot 130, as in the opening location, cylinder 115 contacts slot 130 on the right side at two locations.

During extended use, there may be two wear paths created on cylinder 115, one at each of the two contact points.

FIG. 8B is another section view B-B from FIG. 7. The illustrated example shows pin 110 and cylinder 115 against the left side of slot 130, as in the closing location, cylinder 115 contacts slot 130 on the left side at one location. During extended use, there may be one wear path created on cylinder 115 at the contact point.

Because the opening and closing wear paths are at different locations on cylinder 115, the wear at any path is less than could be realized if there were only one wear path on cylinder 115 at the same location.

During operation of the mechanism to open or close a plug door, several events occur. The upper and lower lock bars are disengaged or engaged and the door moved away from or toward the railcar body. In previous designs, these events happen at the same time. To reduce handle operation forces, in particular embodiments these events occur at different times. This reduces handle forces for the operator. The upper lock bars may be unlocked/locked at a different time than the lower lock bars, and both lock bar events may be timed differently with respect to the horizontal bar movement, which moves the door in and out of its opening.

Particular embodiments may stagger the timing of two lock bar (e.g., lock bar 500) disengagements and engagements in various ways. In some embodiments, the depth of engagement of the lock bars (e.g., lock bars 500) in the rotating plate (e.g., rotating plate 100) may vary. Some embodiments may use different angular positions of the upper and lower lock bars with respect to the center of rotation of the rotating plate. Some embodiments may use other methods to disengage/engage the upper and lower lock bars at different times, or in other words, different amounts of rotation of the rotating plate (and thus the handle). One can appreciate that a multitude of methods or combinations of methods may be used to affect lock bar timing with respect to each other and with respect to door movement but only some examples are shown herein.

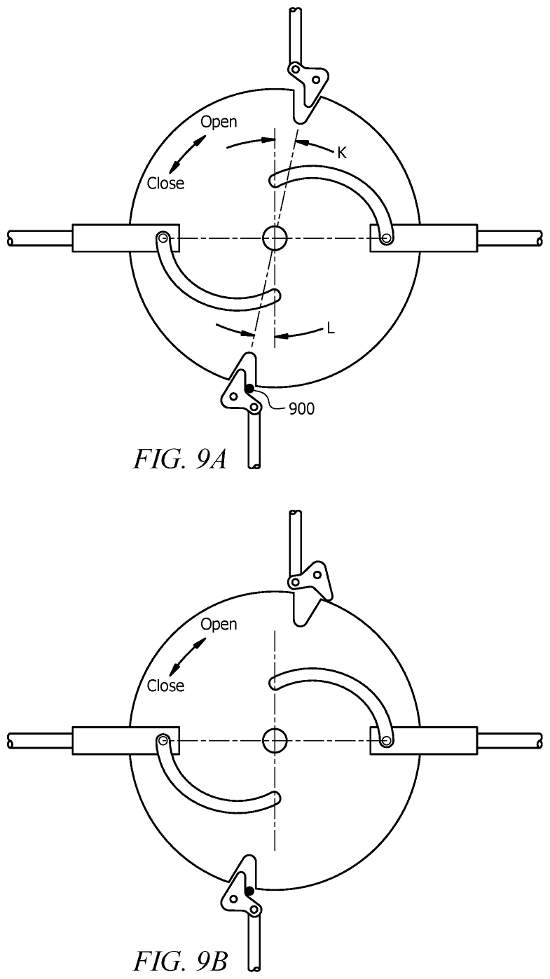

In some embodiments, the locations of upper and lower lock bar engagements to the rotating plate may be at different angular locations and/or the lower lock bar may have a wider engagement slot in the rotating plate. Examples are illustrated in FIGS. 9A and 9B.

FIG. 9A is a schematic diagram illustrating lock bar engagements at different angular locations, according to a particular embodiment. In the illustrated example, upper lock bar 500 is located at angle K from vertical while lower lock bar 500 is located at angle L from vertical, where K is less than L. A stop pin 900 holds the lower lock bar 500 lever away from contacting the rotating plate, allowing the plate to rotate and unlock the upper lock bar 500 before the lower lock bar 500 starts moving.

FIG. 9B is a schematic diagram illustrating lock bar engagements at different angular locations, with a lower lock bar disengaged, according to a particular embodiment. As illustrated, rotating plate 100 rotates further to disengage lower lock bar 500. Upper lock bar 500 is in the unlocked position while the lower lock bar 500 is still in the locked position.

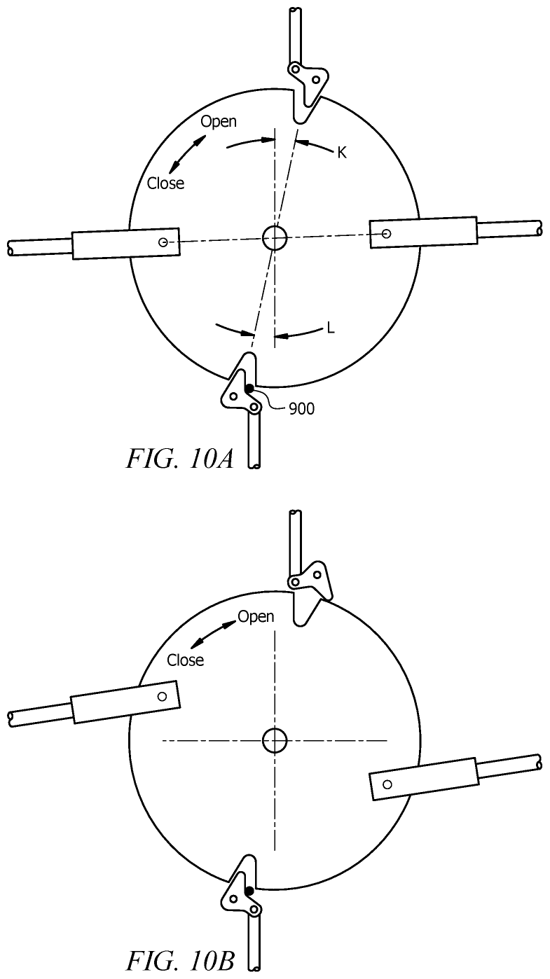

FIGS. 10A and 10B are schematic diagrams illustrating staggered upper and lower lock bar events on a conventional rotating plate, according to a particular embodiment.

Particular examples of the door operating system described herein show upper lock bar disengagement before lower lock bar. However, other options exist for the timing of lock bar disengagements/engagements. In some embodiments, the upper lock bar may be disengaged/engaged before the lower lock bar. In another embodiment, the lower lock bar may be disengaged/engaged before the upper lock bar. Particular embodiments can accommodate either scenario.

One advantage of disengaging one lock bar before the second is safety. If commodity inside the railcar has shifted and is leaning against the door, unlocking only one lock bar may reveal this situation to the door operator, and the door operator may take appropriate steps to mitigate any risk that may occur should the door suddenly open and commodity fall out.

Another advantage is reduced handle operating forces from disengaging only one lock bar at a time. Not only can the upper and lower lock bar engagements be timed to occur at different moments, but also the left and right side door movements can be timed different from each other and different from lock bar engagement/disengagement. Previous designs move both sides of the door move simultaneously together when opening and closing the door. This requires higher handle effort especially when compressing the door seal when closing while trying to engage both lock bars at the same time.

Particular embodiments include opening and closing one side of the door slightly ahead of the other side to reduce handle forces and for other reasons described below, as well as moving the door at a different time than lock bar engagement.

Previous designs require accurate timing between door movement and lock bar movement. Because the lock bars and horizontal rods for door movement are all attached to the rotating plate, any movement of the rotating plate may cause movement in all of these components. Careful timing and tolerances need to be considered such that when opening the door, the door does not move too far outward before the lock bars are disengaged from the railcar body or the lock bars may jam, increasing handle effort or even preventing the door from opening. When closing the door, timing needs to be such that the door is located sufficiently against the railcar body and the door gasket compressed before the lock bars are engaged. Changes in the door mechanism due to wear, temperature, or slight damage may cause the door not to lock, the gasket not to fully compress, the door not to open, or combinations of these.

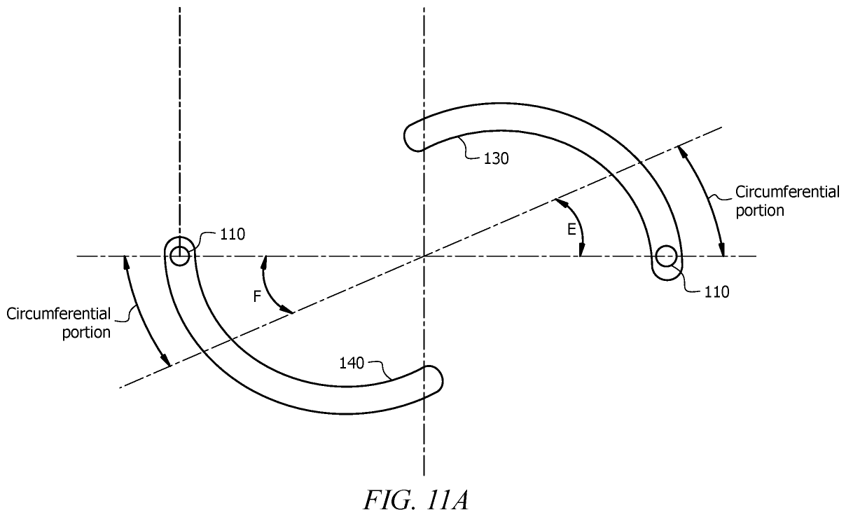

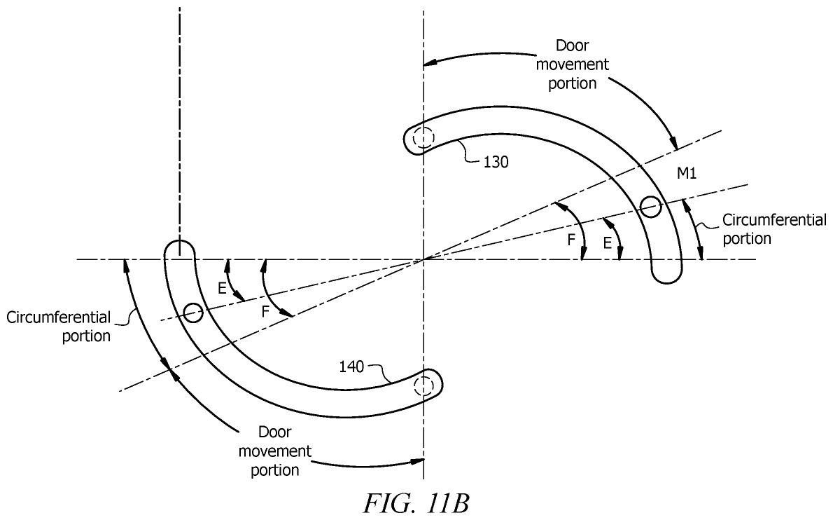

FIGS. 11A and 11B are schematic diagrams illustrating a door operating system where one side of the door opens in advance of the other side, according to a particular embodiment. In the illustrated example, horizontal rod 200 movement is created by pin 110 following slots 130 and 140 as rotating plate 100 is moved. If slots 130 and 140 are purely circumferential to the center of rotation of rotating plate 100, there is no relative movement of horizontal rods 200.

When opening the door and disengaging lock bars 500, pins 110 can travel in circumferential slots 130 and 140 for a period of time while the lock bars 500 disengage, or at some other desired point. An example is illustrated in FIG. 11A, which comprises a drawing of a portion of rotating plate 100.

When opening the door, if slot 140 on the left side of rotating plate 100 has a slightly longer circumferential portion than slot 130 on the right side, right side horizontal rod 200 will start to move the door outward on the right side, decompressing the door gasket before there is movement of horizontal rod 500 on the left side.

FIG. 11A shows right slot 130 has a circumferential slot of length E degrees and left slot 140 has a circumferential slot of F degrees, where F is greater than E. Door lock rods 200 may be disengaged during the movement of rotating plate 100 while pins 110 are in the circumferential portion of slots 130 and 140. At some desired point, depending upon the length of circumferential slot 140 on the left side, the left side of the door will also being moving outward.

The difference in timing may be advantageous for several reasons. One reason is that handle forces may be reduced. Another is that if commodity inside the railcar has shifted and is applying pressure on the door, slight movement of the door on one side may alleviate some or all of the pressure on the door, making the door easier to open through reduced handle forces.

In FIG. 11B, the portion of right slot 130, labeled M1, is no longer circumferential but starts to change radially and begins to pull horizontal rod 200 inward. On the left side, pin 110 is still engaged in the circumferential portion of slot 140 and no movement of left horizontal rod 200 has occurred yet.

Continued rotation of rotating plate 100 moves the door outward. At some desired point, the slot for the left horizontal rod also begins to change radially. Outward movement then simultaneously occurs on both the right and left sides of the door. This continues until the door has moved all the way outward the desired amount. Movement usually ends with the door parallel to the sides of the railcar with sufficient space to roll from in front of the railcar body opening to a place alongside of the railcar side. However, the door does not have to be parallel to the side as long as there is sufficient clearance to fully open the door.

Because the door is parallel to the railcar body when closed, and it may be desired to be parallel when fully open, the starting and ending points for pins 110 in slots 130 and 140 may be the same. Because right slot 130 moved horizontal rod 200 before the left side, slot 140 has a longer circumferential portion, there is less slot 140 door movement length on the left side to make up for total door movement. Therefore, slot 140 on the left side may curve in more sharply than the right side so pins 110 end up at equally symmetrical locations with respect to each other.

When closing the door, the movements are reversed in order from above. The door is rolled in front of the door opening in the railcar body, the handle is turned in the opposite direction from the opening direction, and the door starts to move inward. Due to the different curvature of left slot 140 than right slot 130, the left side of the door moves more quickly and a little further than the right side. Continued rotation of the handle begins to compress the portion of the gasket along the vertical left side of the door. Continued handle rotation begins to compress portions of the door gasket along the top and bottom of the door from left to right. When the left door gasket is fully compressed, the vertical portion of the gasket along the vertical right side of the door begins to compress. After the gasket is fully compressed, lock bars 500 are engaged, first one set followed by the second set, if applicable.

The embodiments described herein include particular embodiments for door opening and closing. One practiced in the art can appreciate the elements described herein may be used to open and close doors in the opposite left-right direction, change timing elements between the lock bars and horizontal rods, be applied to one, two or more sets of horizontal rods and lock bars, etc. Particular embodiments are also applicable to double plug doors and sliding doors. Particular embodiments are also applicable to doors on other vehicles, such as trucks, marine vessels, etc. Particular embodiments may be applicable to doors on storage containers, buildings, etc.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as falling within the scope of this disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Modifications, additions, or omissions may be made to the methods disclosed herein without departing from the scope of the invention. The methods may include more, fewer, or other steps. Additionally, steps may be performed in any suitable order.

1. A door operating system comprising:
a rotating plate, a first lock bar, and a second lock bar;
the rotating plate comprising a first lock bar engagement for engaging and disengaging the first lock bar;
the rotating plate comprising a second lock bar engagement for engaging and disengaging the second lock bar; and
wherein an angular position of the first lock bar engagement with respect to a center of rotation of the rotating plate is different than an angular position of the second lock bar engagement with respect to the center of rotation of the rotating plate such that rotation of the rotating plate engages or disengages the first lock bar at a different time than the second lock bar.

2. The door operating system of claim 1, wherein the first lock bar engagement is a different size than the second lock bar engagement.

3. The door operating system of claim 1, wherein the second lock bar engagement comprises a stop pin.

4. The door operating system of claim 1, further comprising:
a first horizontal rod and a second horizontal rod;
the first horizontal rod is coupled to the rotating plate via first slot in the rotating plate;
the second horizontal rod is coupled to the rotating plate via a second slot in the rotating plate; wherein:
a first portion of the first slot is circumferential to the rotating plate and a second portion of the first slot is not circumferential to the rotating plate;
a first portion of the second slot is circumferential to the rotating plate and a second portion of the second slot is not circumferential to the rotating plate; and
the first and second portions of the first slot are offset from the first and second portions of the second slot so that the first horizontal rod and the second horizontal rod start and stop horizontal movement at different times with respect to each other when the rotating plate is rotated.

5. The door operating system of claim 4, wherein:
the first horizontal rod comprises a pin and is coupled to the rotating plate via the pin and the first slot, wherein the pin is smaller in diameter than the first slot and when operating the rotating plate in the opening direction the pin is in contact with a first side of the first slot and when operating the rotating plate in the closing direction the pin is in contact with a second side of the first slot opposite the first side.

6. The door operating system of claim 5, wherein the pin comprises a low friction material.

7. The door operating system of claim 5, wherein the pin comprises a rotating cylinder that facilitates rolling motion between the pin and the first slot.

8. A door operating system comprising:
a rotating plate, a first horizontal rod, and a second horizontal rod;
the first horizontal rod is coupled to the rotating plate via first slot in the rotating plate;
the second horizontal rod is coupled to the rotating plate via a second slot in the rotating plate; wherein:
a first portion of the first slot is circumferential to the rotating plate and a second portion of the first slot is not circumferential to the rotating plate;
a first portion of the second slot is circumferential to the rotating plate and a second portion of the second slot is not circumferential to the rotating plate; and
the first and second portions of the first slot are offset from the first and second portions of the second slot so that the first horizontal rod and the second horizontal rod start and stop horizontal movement at different times with respect to each other when the rotating plate is rotated.

9. The door operating system of claim 8, wherein:
the first horizontal rod comprises a pin and is coupled to the rotating plate via the pin and the first slot, wherein the pin is smaller in diameter than the first slot and operating the rotating plate in the opening direction the pin is in contact with a first side of the first slot and when operating the rotating plate in the closing direction the pin is in contact with a second side of the first slot opposite the first side.

10. The door operating system of claim 9, wherein the pin comprises a low friction material.

11. The door operating system of claim 9, wherein the pin comprises a rotating cylinder that facilitates rolling motion between the pin and the first slot.

12. The door operating system of claim 8, further comprising:
a first lock bar and a second lock bar;
the rotating plate comprising a first lock bar engagement for engaging and disengaging the first lock bar;
the rotating plate comprising a second lock bar engagement for engaging and disengaging the second lock bar; and
wherein an angular position of the first lock bar engagement with respect to a center of rotation of the rotating plate is different than an angular position of the second lock bar engagement with respect to the center of rotation of the rotating plate such that rotation of the rotating plate engages and disengages the first lock bar at a different time than the second lock bar.

13. The door operating system of claim 8, wherein the first lock bar engagement is a different size than the second lock bar engagement.

14. The door operating system of claim 8, wherein the second lock bar engagement comprises a stop pin.

15. A method for operating a railcar door, the door comprising a handle, a first door lock, and a second door lock, the method comprising:
rotating the handle in a first direction to disengage the first door lock; and
further rotating the handle in the first direction to disengage the second door lock.

16. The method of claim 15, the door further comprising a first horizontal rod for actuating a first door crank arm and a second horizontal rod for actuating a second door crank arm, the method further comprising:
further rotating the handle in the first direction to activate the first horizontal rod; and
further rotating the handle in the first direction to activate the second horizontal rod.

17. The method of claim 15, the method further comprising:
rotating the handle in a second direction to deactivate the second horizontal rod; and
further rotating the handle in the second direction to deactivate the first horizontal rod.

18. The method of claim 17, the method further comprising:
further rotating the handle in the second direction to engage the second door lock; and
further rotating the handle in the second direction to engage the first door lock.
